(19) United States
(12) Patent Application Publication
(10) Pub. No.: US 2025/0383513 A1
(43) Pub. Date: Dec. 18, 2025

(54) Methods for Optical Fiber Attachment to Photonic Integrated Chip

(71) Applicant: Ayar Labs, Inc., San Jose, CA (US)

(72) Inventors: Li-Fan Yang, Newark, CA (US); Albert Zettler Greely, JR., Santa Clara, CA (US); Chong Zhang, San Jose, CA (US); Haiwei Lu, San Jose, CA (US); Rui Li, San Jose, CA (US); Lijuan Chen, Fremont, CA (US); Ken Jian Ming Wang, Milpitas, CA (US)

(21) Appl. No.: 19/236,080

(22) Filed: Jun. 12, 2025

Related U.S. Application Data
(60) Provisional application No. 63/660,887, filed on Jun. 17, 2024.

(51) Int. Cl. G02B 6/42

(52) U.S. Cl. CPC G02B 6/4243; G02B 6/4239

(57) ABSTRACT

Optical fibers are disposed within v-grooves of an optical fiber attachment region of a photonic integrated chip (PIC). A structural adhesive is disposed over a first portion of the optical fibers within the optical fiber attachment region of the PIC without being disposed over a second portion of the optical fibers within the optical fiber attachment region of the PIC. An optical index matching adhesive is disposed over the second portion of the optical fibers within the optical fiber attachment region of the PIC. A buffer structure is disposed on the structural adhesive and the optical index matching adhesive as they are cured. The buffer structure is removed. The optical fibers, the structural adhesive, and the optical index matching adhesive have a collective vertical height above a top surface of the PIC that is less than a vertical height of flip-chip attachment structures on the top surface of the PIC.

### CROSS-REFERENCE TO RELATED APPLICATIONS

This application claims priority under 35 U.S.C. 119 (e) to U.S. Provisional Patent Application No. 63/660,887, filed on Jun. 17, 2024, the disclosure of which is incorporated herein by reference in its entirety for all purposes.

### BACKGROUND OF THE INVENTION

Optical data communication systems operate by modulating laser light to encode digital data patterns within optical signals. In some embodiments, a ring modulator is used to modulate continuous wave laser light to generate the modulated laser light that conveys the encoding of digital data patterns. In some embodiments, the ring modulator is positioned within an evanescent optically coupling distance from a bus optical waveguide and operates to modulate light that is propagating through the bus optical waveguide. The ring modulator and associated optical waveguides are fabricated within an electro-optic chip and/or photonic integrated chip. The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and photonic integrated circuits within electro-optic and/or photonic integrated chips. Implementation and operation of optical data communication systems is dependent upon having reliable and efficient techniques for connection of optical fibers to electro-optic and/or photonic chips. It is within this context that the present invention arises.

### SUMMARY OF THE INVENTION

In an example embodiment, a method is disclosed for attaching optical fibers to a photonic integrated chip. The method includes securing the photonic integrated chip and a fiber array unit to a carrier, such that optical fibers of the fiber array unit are disposed within respective v-grooves within an optical fiber attachment region of the photonic integrated chip. The method also includes disposing a structural adhesive over a first portion of the optical fibers within the optical fiber attachment region of the photonic integrated chip without disposing the structural adhesive over a second portion of the optical fibers within the optical fiber attachment region of the photonic integrated chip. The method also includes disposing an optical index matching adhesive over the second portion of the optical fibers within the optical fiber attachment region of the photonic integrated chip. The method also includes disposing an adhesion-free buffer structure onto both the structural adhesive and the optical index matching adhesive so as to press the optical fibers into the respective v-grooves. The method also includes curing both the structural adhesive and the optical index matching adhesive while the adhesion-free buffer structure is disposed onto both the structural adhesive and the optical index matching adhesive. The optical fibers, the structural adhesive after curing, and the optical index matching adhesive after curing have a collective vertical height above a top surface of the photonic integrated chip that does not exceed a vertical height of electrically conductive flip-chip attachment structures present on the top surface of the photonic integrated chip.

In an example embodiment, an apparatus is disclosed to include a photonic integrated chip that includes a plurality of v-grooves for connection of optical fibers. The apparatus also includes a plurality of flip-chip attachment structures disposed on a top surface of the photonic integrated chip. Each of the plurality of flip-chip attachment structures has a vertical height above the top surface of the photonic integrated chip. The apparatus also includes a fiber array unit that includes a plurality of optical fibers disposed respectively within the plurality of v-grooves of the photonic integrated chip. The apparatus also includes a structural adhesive disposed and cured over a first portion of the optical fibers within the v-grooves of the photonic integrated chip. The apparatus also includes an optical index matching adhesive disposed and cured over a second portion of the optical fibers within the v-grooves of the photonic integrated chip. The second portion of the optical fibers does not have the structural adhesive disposed thereon. The optical fibers, the structural adhesive, and the optical index matching adhesive have a collective vertical height above the top surface of the photonic integrated chip that is less than the vertical height of the plurality of flip-chip attachment structures above the top surface of the photonic integrated chip.

In an example embodiment, a method is disclosed for attaching optical fibers to a photonic integrated chip. The method includes securing the photonic integrated chip and a fiber array unit to a carrier, such that optical fibers of the fiber array unit are disposed within respective v-grooves within an optical fiber attachment region of the photonic integrated chip. The method also includes disposing an optical index matching adhesive over a first portion of the optical fibers within the optical fiber attachment region of the photonic integrated chip without disposing the optical index matching adhesive over a second portion of the optical fibers within the optical fiber attachment region of the photonic integrated chip. The method also includes disposing an attachment film over the second portion of the optical fibers within the optical fiber attachment region of the photonic integrated chip. The method also includes disposing an adhesion-free layer over both the attachment film and the optical index matching adhesive. The method also includes disposing a buffer structure over the adhesion-free layer so as to press the optical fibers into the respective v-grooves through the adhesion-free layer. The method also includes curing the attachment film and the optical index matching adhesive while the buffer structure is disposed to press the optical fibers into the respective v-grooves through the adhesion-free layer. The optical fibers, the attachment film after curing, and the optical index matching adhesive after curing have a collective vertical height above a top surface of the photonic integrated chip that is less than a vertical height of electrically conductive flip-chip attachment structures present on the top surface of the photonic integrated chip.

In an example embodiment, an apparatus is disclosed to include a photonic integrated chip that includes a plurality of v-grooves for connection of optical fibers. The apparatus also includes a plurality of flip-chip attachment structures disposed on a top surface of the photonic integrated chip. Each of the plurality of flip-chip attachment structures has a vertical height above the top surface of the photonic integrated chip. The apparatus also includes a fiber array unit that includes a plurality of optical fibers disposed respectively within the plurality of v-grooves of the photonic integrated chip. The apparatus also includes an attachment film disposed and cured over a first portion of the optical fibers within the v-grooves of the photonic integrated chip. The apparatus also includes an optical index matching adhesive disposed and cured over a second portion of the optical fibers within the v-grooves of the photonic integrated chip. The second portion of the optical fibers does not have the attachment film disposed thereon. The optical fibers, the attachment film, and the optical index matching adhesive have a collective vertical height above the top surface of the photonic integrated chip that is less than the vertical height of the plurality of flip-chip attachment structures above the top surface of the photonic integrated chip.

Other aspects and advantages of the disclosed embodiments will become more apparent from the following detailed description, taken in conjunction with the accompanying drawings, illustrating by way of example the disclosed embodiments.

### BRIEF DESCRIPTION OF THE DRAWINGS

FIG. 1 shows a flowchart of a method for attaching a fiber array unit (FAU) to a photonic integrated chip (PIC), in accordance with some embodiments.

FIG. 2A shows a top view of the PIC, with the FAU disposed within a fiber attachment region of the PIC, in accordance with some embodiments.

FIG. 2B shows a vertical cross-section view through the PIC, with the FAU disposed within a fiber attachment region of the PIC, referenced as View A-A in FIG. 2A, in accordance with some embodiments.

FIG. 2C shows a vertical cross-section view through the FAU looking toward the PIC, referenced as View B-B in FIG. 2A, in accordance with some embodiments.

FIG. 2D shows a top view of the fiber attachment region of the PIC, referenced as View C-C in FIG. 2C, in accordance with some embodiments.

FIG. 2E shows a vertical cross-section of the PIC prepared on a carrier (or substrate), in accordance with some embodiments.

FIG. 2F shows the vertical cross-section of the PIC on the carrier, as shown in FIG. 2E, with the FAU positioned for attachment with the PIC, in accordance with some embodiments.

FIG. 2G shows a close-up vertical cross-section view of the fiber attachment region of the PIC, in accordance with some embodiments.

FIG. 2H shows the vertical cross-section of the PIC and the FAU attached to the carrier, with the optical fibers of the FAU disposed within the v-grooves of the PIC, and with the structural adhesive and the optical index matching adhesive disposed over the optical fibers within the fiber attachment region of the PIC, in accordance with some embodiments.

FIG. 2I shows a close-up of a top view of any one of the optical fibers disposed within its respective v-groove, with the structural adhesive and the optical index matching adhesive disposed over the optical fibers, in accordance with some embodiments.

FIG. 2J shows a top view of a chip flip-chip attached to the PIC, in accordance with some embodiments.

FIG. 2K shows a vertical cross-section view through the chip flip-chip attached to the PIC, referenced as View A-A in FIG. 2J, in accordance with some embodiments.

FIG. 3A shows a top view of a chip flip-chip attached to the PIC, where the chip does not include the cutout region, in accordance with some embodiments.

FIG. 3B shows a vertical cross-section view of the FAU and chip attached to the PIC, without the buffer structure present, referenced as View A-A in FIG. 3A, in accordance with some embodiments.

FIG. 4 shows a flowchart of a method for attaching the FAU to the PIC, without leaving the buffer structure secured to the FAU and PIC, in accordance with some embodiments.

FIG. 5A shows a vertical cross-section of the PIC attached to the carrier by way of the securing material, in accordance with some embodiments.

FIG. 5B shows a close-up of a top view of any one of the optical fibers disposed within its respective v-groove, with both the structural adhesive and the optical index matching adhesive disposed over the optical fibers, in accordance with some embodiments.

FIG. 5C shows the configuration of FIG. 5A with the adhesion-free buffer structure disposed onto both the structural adhesive and the optical index matching adhesive, over the optical fibers within the fiber attachment region of the PIC, in accordance with some embodiments.

FIG. 5D shows the configuration of FIG. 5C, with the adhesion-free buffer structure removed from the optical fibers after curing of the structural adhesive and the optical index matching adhesive, in accordance with some embodiments.

FIG. 5E shows the PIC and the FAU being released from the carrier, in accordance with some embodiments.

FIG. 5F shows a chip flip-chip attached to the PIC after release of the FAU and the PIC from the carrier, in accordance with some embodiments.

FIG. 5G shows a top view of the chip, in accordance with some embodiments.

FIG. 6 shows a flowchart of a method for attaching the optical fibers to the PIC, in accordance with some embodiments.

FIG. 7 shows a flowchart of a method for attaching the FAU to the PIC, without leaving the buffer structure secured to the FAU and PIC, in accordance with some embodiments.

FIG. 8A shows a top view of the PIC attached to the carrier by way of the securing material, in accordance with some embodiments.

FIG. 8B shows a vertical cross-section view of the PIC attached to the carrier by way of the securing material, referenced as View A-A in FIG. 8A, in accordance with some embodiments.

FIG. 8C shows a vertical cross-section view through the configuration of FIG. 8B with the attachment film disposed onto the optical fibers, in accordance with some embodiments.

FIG. 8D shows a top view of the FAU and the PIC secured to the carrier by way of the securing material, with the attachment film and the optical index matching adhesive disposed over the optical fibers, in accordance with some embodiments.

FIG. 8E shows the configuration of FIG. 8C with the buffer structure disposed on the adhesion-fee layer, in accordance with some embodiments.

FIG. 8F shows the configuration of FIG. 8E after removal of the buffer structure and the adhesion-free layer, in accordance with some embodiments.

FIG. 8G shows the configuration of FIG. 8F with the PIC and the FAU being released from the carrier, in accordance with some embodiments.

FIG. 8H shows the PIC and the FAU configuration of FIG. 8G with a chip flip-chip attached to the PIC, in accordance with some embodiments.

FIG. 8I shows a top view of the chip of FIG. 8H, in accordance with some embodiments.

FIG. 9 shows a flowchart of a method for attaching optical fibers to a photonic integrated chip.

### DETAILED DESCRIPTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

In some embodiments, an electro-optic chip or photonic integrated chip or other type of optical device includes a v-groove array in which optical fibers are positioned and secured, such that the optical cores of the optical fibers are optically aligned with respective optical waveguides within the chip/device. In some embodiments, a passive fiber assembly process using the v-groove array includes having a lid attached on top of a portion of a fiber array unit (FAU) that includes the plurality of optical fibers disposed within the v-groove array. In some embodiments, a structural adhesive is used to secure the optical fibers of the FAU in the respective v-grooves of the v-groove array. Also, in some embodiments, the lid that attaches to the portion of the FAU at the location over the v-groove array provides a clamping mechanism that serves to facilitate optical alignment of the optical cores of the optical fibers of the FAU to the respective optical waveguides within the chip/device.

It should be appreciated, however, that use of the lid to provide for optical alignment and mechanical securing of the optical fibers of the FAU within the v-groove array requires introduction/addition of the lid into the overall chip/device package assembly, which introduces additional uncertainty and risk to a subsequent (downstream) reliability and qualification process. Also, with regard to mechanical fit-up of the lid into the overall chip/device package assembly, the lid and the structural adhesive used to install the lid collectively introduce an additional thickness that has to be accommodated within the overall chip/device package assembly. In some embodiments, a substrate/device is to be attached, e.g., flip-chip connected, to the electro-optic chip that includes the v-groove array within which the FAU is secured. In some embodiments, the additional thickness of the lid and associated structural adhesive exceeds the vertical height of the micro bumps present on one or both of the substrate/device and electro-optic chip, such that substrate/device does not vertically clear the lid when the substrate/device is flip-chip connected to the electro-optic chip. Therefore, in these embodiments, the substrate/device is required to have a cut-out region in order to prevent collision between the substrate/device and the lid when the substrate/device is flip-chip connected to the electro-optic chip. Various embodiments are disclosed herein for a lidless assembly process for passive optical fiber array attachment on v-groove. The various embodiments disclosed herein provide for an overall chip/device package assembly that does not have a lid on top of the FAU over the v-groove array after final curing of the adhesive that secures the optical fibers of the FAU within the v-groove array.

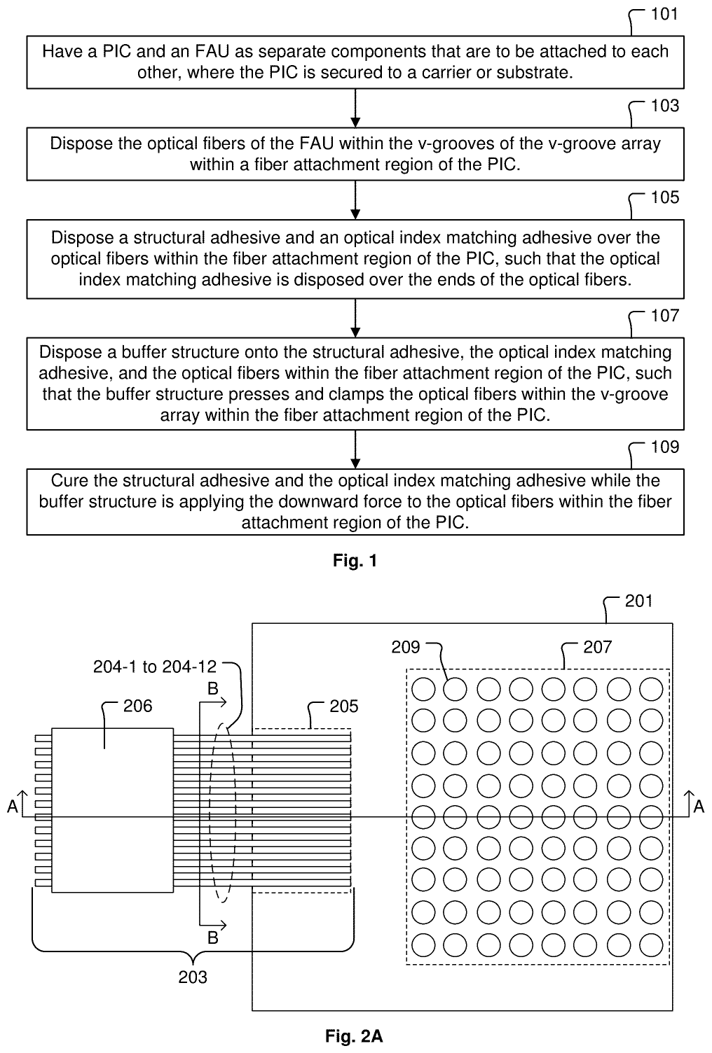

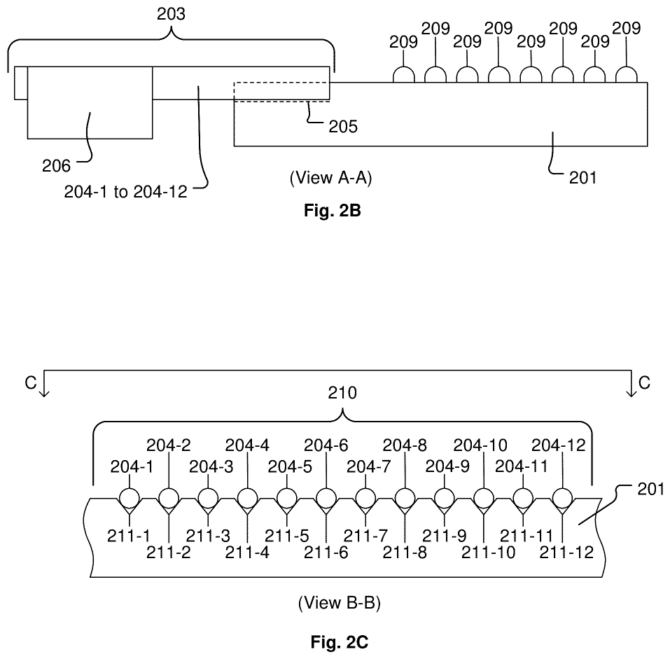

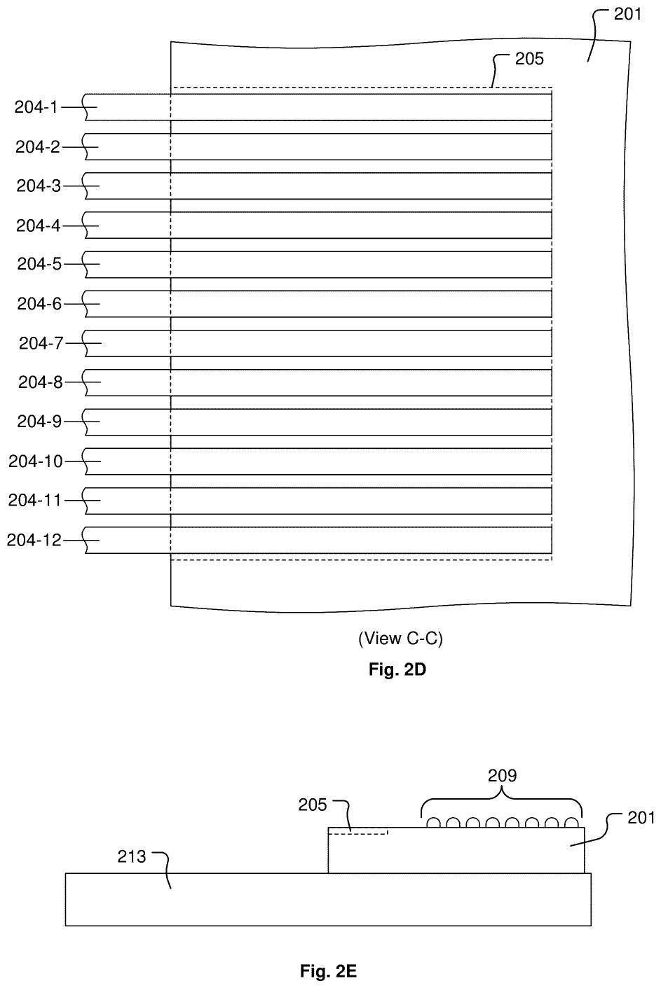

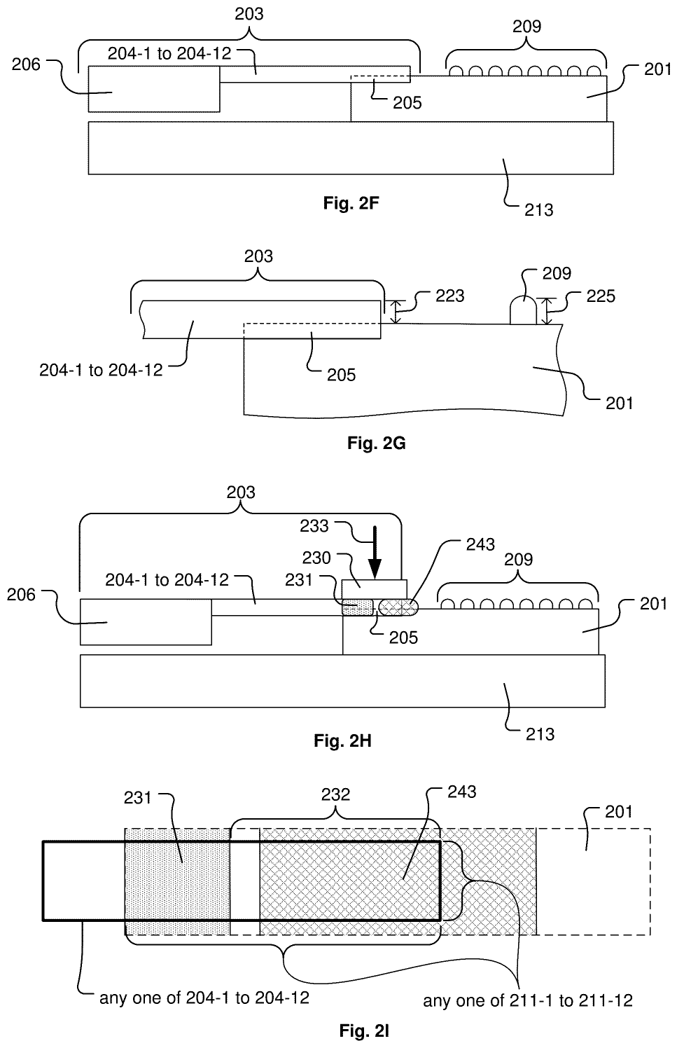

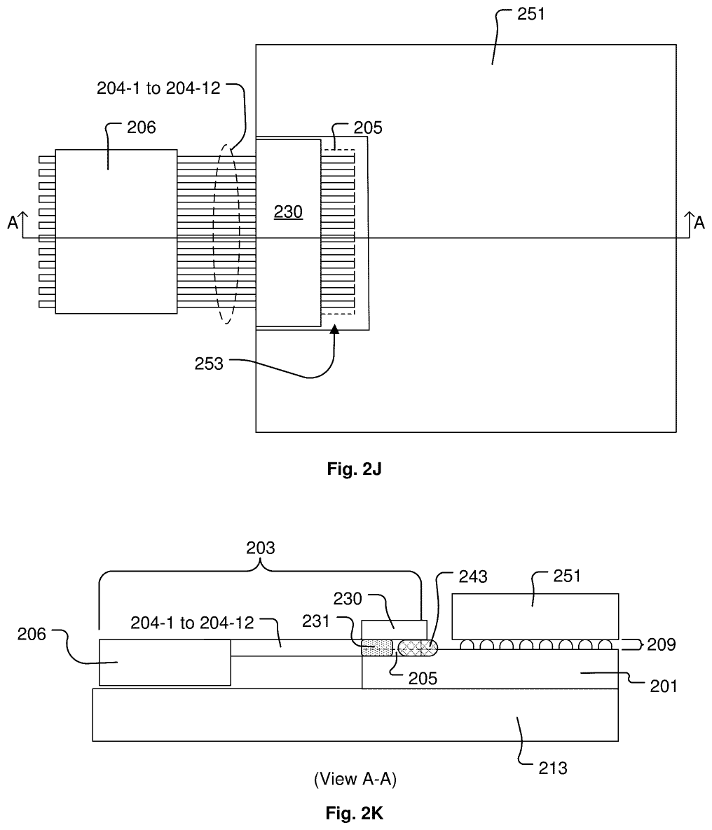

FIG. 1 shows a flowchart of a method for attaching an FAU 203 to a photonic integrated chip (PIC) 201, in accordance with some embodiments. The method includes an operation 101 for having the PIC 201 and the FAU 203 as separate components that are to be attached to each other. The PIC 201 and the FAU 203 are generally described with regard to FIGS. 2A-2D. It should be understood that the PIC 201 and the FAU 203 include additional features and details that are not shown in FIGS. 2A-2D in order to avoiding unnecessarily obscuring the features of the PIC 201 and the FAU 203 that are relevant to various embodiments disclosed herein.

FIG. 2A shows a top view of the PIC 201, with the FAU 203 disposed within a fiber attachment region 205 of the PIC 201, in accordance with some embodiments. FIG. 2B shows a vertical cross-section view through the PIC 201, with the FAU 203 disposed within a fiber attachment region 205 of the PIC 201, referenced as View A-A in FIG. 2A, in accordance with some embodiments. FIG. 2C shows a vertical cross-section view through the FAU 203 looking toward the PIC 201, referenced as View B-B in FIG. 2A, in accordance with some embodiments. FIG. 2D shows a top view of the fiber attachment region 205 of the PIC 201, referenced as View C-C in FIG. 2C, in accordance with some embodiments. It should be understood that the PIC 201 and the FAU 203 are not drawn to scale in the various figures, but are presented in a manner to facilitate description of the various embodiments disclosed herein. Also, it should be understood that the PIC 201 and the FAU 203 are provided by way of example and are not to be considered as limiting to the various embodiment disclosed herein. For example, in various embodiments, each of the PIC 201 and the FAU 203 can have different shapes and sizes. In some embodiments, the PIC 201 includes an array 207 of electrically conductive bumps 209 to enable flip-chip attachment of the PIC 201 to another electronic device, such as to another chip, substrate, interposer, printed circuit board, or essentially any other electronic device. Each of the circles shown with the array 207 represent the electrically conductive bumps 209. In some embodiments, the electrically conductive bumps 209 are copper pillar bumps. However, it should be understood that in various embodiments the electrically conductive bumps 209 can be any type of electrically conductive bump and/or pillar structure, and can be made of any type of electrically conductive material, as known the art of semiconductor device packaging.

In some embodiments, the fiber attachment region 205 of the PIC 201 is configured as an array 210 of v-grooves 211-1 to 211-12, where each of the v-grooves 211-1 to 211-12 is formed as a v-shaped trench within a top surface of the PIC 201, and where the v-grooves 211-1 to 211-12 extend into the PIC 201 from an edge of the PIC 201 in a substantially parallel manner with respect to each other. In some embodiments, the FAU 203 includes a plurality of optical fibers 204-1 to 204-12 collectively supported by a lid structure 206. In some embodiments, the lid structure 206 is configured as a one-sided lid structure, such that the plurality of optical fibers 204-1 to 204-12 are disposed proximate to a top surface of the lid structure 206, such as shown in the vertical cross-section view of FIG. 2B. The example FAU 203 includes twelve optical fibers 204-1 to 204-12 corresponding to twelve optical channels. However, it should be understood that in other embodiments, the FAU 203 can include any non-zero number of optical fibers. Each of the v-grooves 211-1 to 211-12 is configured to receive and align a respective one of the optical fibers 204-1 to 204-12, such that a core of the respective one of the optical fibers 204-1 to 204-12 is optically coupled with a respective optical input of the PIC 201. In various embodiments, the optical inputs of the PIC 201 are configured as one or more of an optical waveguide, a lens, an optical grating coupler, or essentially any other type of optical input device known in the art of integrated photonics.

FIG. 2E shows a vertical cross-section of the PIC 201 prepared on a carrier (or substrate) 213, in accordance with some embodiments. In some embodiments, the carrier 213 is a silicon substrate, such as a silicon carrier wafer. In some embodiments, the carrier 213 is a glass substrate. It should be understood that the carrier 213 can be formed of any material that is usable as a carrier wafer or carrier substrate in the art of semiconductor manufacturing. In some embodiments, the carrier 213 is intended to be permanently attached to the PIC 201.

The method of FIG. 1 continues from the operation 101 with an operation 103 for disposing the optical fibers 204-1 to 204-12 of the FAU 203 within the v-grooves 211-1 to 211-12 of the v-groove array 210 within the fiber attachment region 205 of the PIC 201. FIG. 2F shows the vertical cross-section of the PIC 201 on the carrier 213, as shown in FIG. 2E, with the FAU 203 positioned for attachment with the PIC 201, in accordance with some embodiments.

FIG. 2G shows a close-up vertical cross-section view of the fiber attachment region 205 of the PIC 201, in accordance with some embodiments. Once the optical fibers 204-1 to 204-12 are fully seated within the v-grooves 211-1 to 211-12, respectively, the optical fibers 204-1 to 204-12 extend a vertical distance 223 above the top surface of the PIC 201. In some embodiments, the vertical distance 223 is less than or equal to a vertical distance 225 that the electrically conductive bumps 209 extend above the top surface of the PIC 201. In some embodiments, the vertical distance 225 is about 45 micrometers. However, in various embodiments, the vertical distance 225 can be either greater than or less than 45 micrometers.

With reference back to FIG. 1, the method continues from the operation 103 with an operation 105 for disposing a structural adhesive 231 and an optical index matching adhesive 243 over the optical fibers 204-1 to 204-12 within the fiber attachment region 205 of the PIC 201. The structural adhesive 231 is disposed over the optical fibers 204-1 to 204-12 at a location away from the ends of the optical fibers 204-1 to 204-12, so as to avoid optical interference of the structural adhesive 231 with light transfer into and/or out of the optical fibers 204-1 to 204-12. In some embodiments, the structural adhesive 231 is an epoxy. In some embodiments, the optical index matching adhesive 243 is an epoxy. However, in various embodiments, the optical index matching adhesive 243 can be any optical index matching adhesive used in the photonics industry. FIG. 2H shows the vertical cross-section of the PIC 201 and the FAU 203 attached to the carrier 213, with the optical fibers 204-1 to 204-12 of the FAU 203 disposed within the v-grooves 211-1 to 211-12 of the PIC 201, and with the structural adhesive 231 and the optical index matching adhesive 243 disposed over the optical fibers 204-1 to 204-12 within the fiber attachment region 205 of the PIC 201, in accordance with some embodiments. FIG. 2I shows a close-up of a top view of any one of the optical fibers 204-1 to 204-12 disposed within its respective v-groove 211-1 to 211-12, with the structural adhesive 231 and the optical index matching adhesive 243 disposed over the optical fibers 204-1 to 204-12, in accordance with some embodiments. The structural adhesive 231 is disposed such that a portion 232 of the optical fibers 204-1 to 204-12 within the fiber attachment region 205 of the PIC 201 does not have the structural adhesive 231 disposed thereon.

The method of FIG. 1 continues from the operation 105 with an operation 107 for disposing a buffer structure 230 onto the structural adhesive 231, the optical index matching adhesive 243, and the optical fibers 204-1 to 204-12 within the fiber attachment region 205 of the PIC 201. FIG. 2H shows the buffer structure 230 disposed onto the structural adhesive 231, the optical index matching adhesive 243, and the optical fibers 204-1 to 204-12 within the fiber attachment region 205 of the PIC 201, as indicated by arrow 233, in accordance with some embodiments. In some embodiments, the buffer structure 230 is configured to substantially cover the structural adhesive 231, the optical index matching adhesive 243, and the optical fibers 204-1 to 204-12 within the fiber attachment region 205 of the PIC 201. In various embodiments, the buffer structure 230 is formed of aluminum, stainless steel, silicon, quartz, plastic, ceramic, or essentially any other material used in semiconductor fabrication that has sufficient mechanical strength to press and hold the optical fibers 204-1 to 204-12 within their respective v-grooves 211-1 to 211-12. In some embodiments, the buffer structure 230 has a vertical thickness 235 of about 400 micrometers, such that the buffer structure 230 extends relatively far above the electrically conductive bumps 209.

The method of FIG. 1 continues from the operation 107 with an operation 109 for curing the structural adhesive 231 and the optical index matching adhesive 243 while the buffer structure 230 is applying the downward force to the optical fibers 204-1 to 204-12. In some embodiments, an ultraviolet (UV) light is used to affect curing of the structural adhesive 231 and the optical index matching adhesive 243.

FIG. 2J shows a top view of a chip 251 flip-chip attached to the PIC 201, in accordance with some embodiments. The chip 251 is an integrated circuit chip. FIG. 2K shows a vertical cross-section view through the chip 251 flip-chip attached to the PIC 201, referenced as View A-A in FIG. 2J, in accordance with some embodiments. In some embodiments, the chip 251 is necessarily configured to have a cutout region 253 to accommodate positioning of the chip 251 in flip-chip attachment to the PIC 201 and to avoid interference between the chip 251 and the buffer structure 230 overlying the fiber attachment region 205 of the PIC 201. Various alternative FAU/optical fiber-to-PIC attachment processes are disclosed herein that avoid having the buffer structure 230 overlying the fiber attachment region 205 of the PIC 201, and that in turn avoid having to form the cutout region 253 within the chip 251 that is flip-chip attached to the PIC 201 by way of the electrically conductive bumps 209.

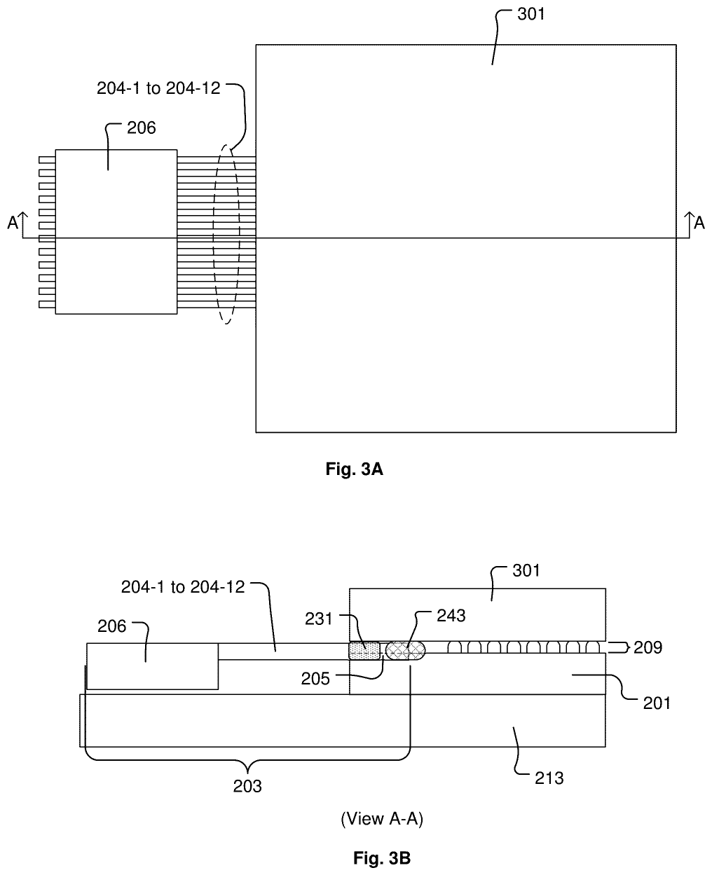

FIG. 3A shows a top view of a chip 301 flip-chip attached to the PIC 201, where the chip 301 does not include the cutout region 253, in accordance with some embodiments. FIG. 3B shows a vertical cross-section view of the FAU 203 and chip 301 attached to the PIC 201, without the buffer structure 230 present, referenced as View A-A in FIG. 3A, in accordance with some embodiments. It should be appreciated that by not having to form the cutout region 253 within the chip 301 to accommodate the placement of the buffer structure 230, the manufacturing of the chip 301 is simplified and the cost of the chip 301 is correspondingly decreased. Also, by not having the cutout region 253 within the chip 301 to accommodate the placement of the buffer structure 230, the overall area of the chip 301 that is available for use in forming electronic devices and/or wiring is increased, which affords implementation of additional functionality within the chip 301 and eases floorplan crowding within the chip 301, among other benefits. Therefore, it is of particular interest to have methods for attachment of the FAU 203 to the PIC 201 that do not require use of the buffer structure 230.

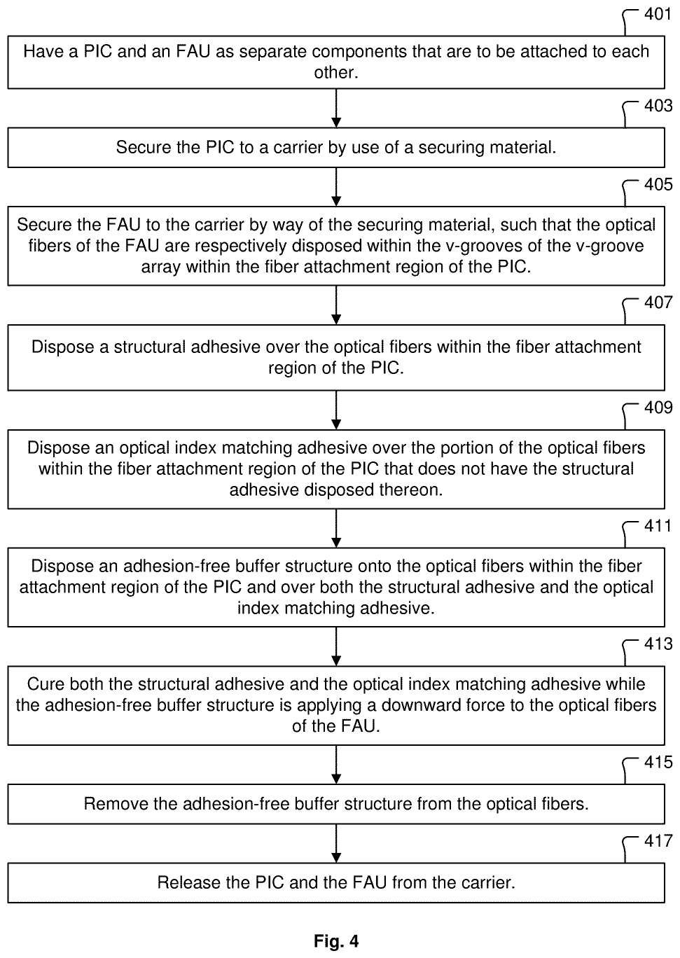

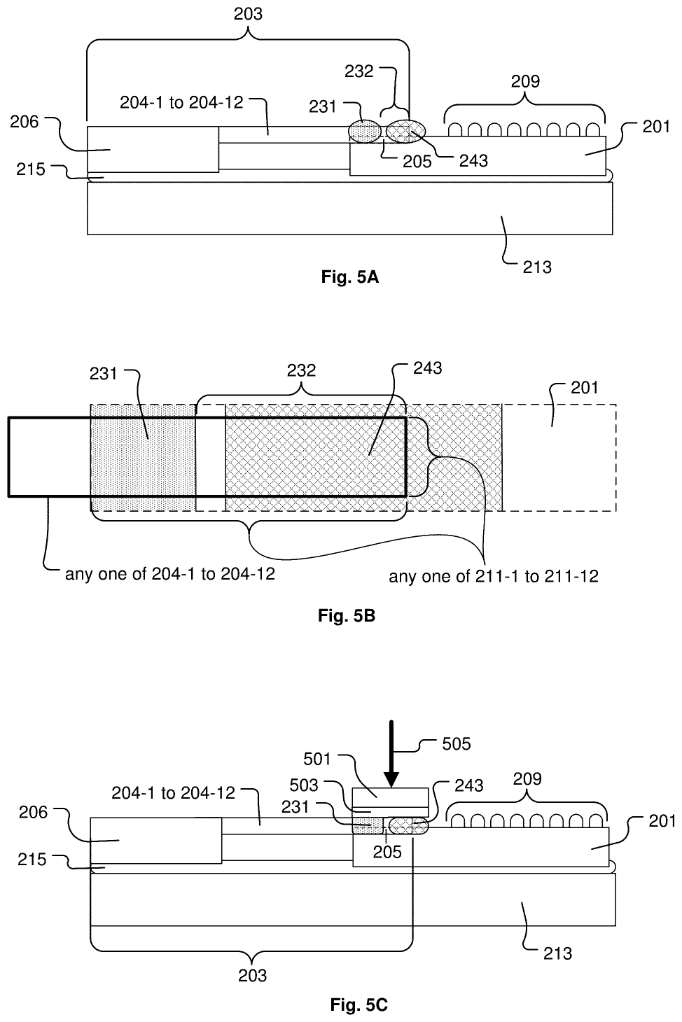

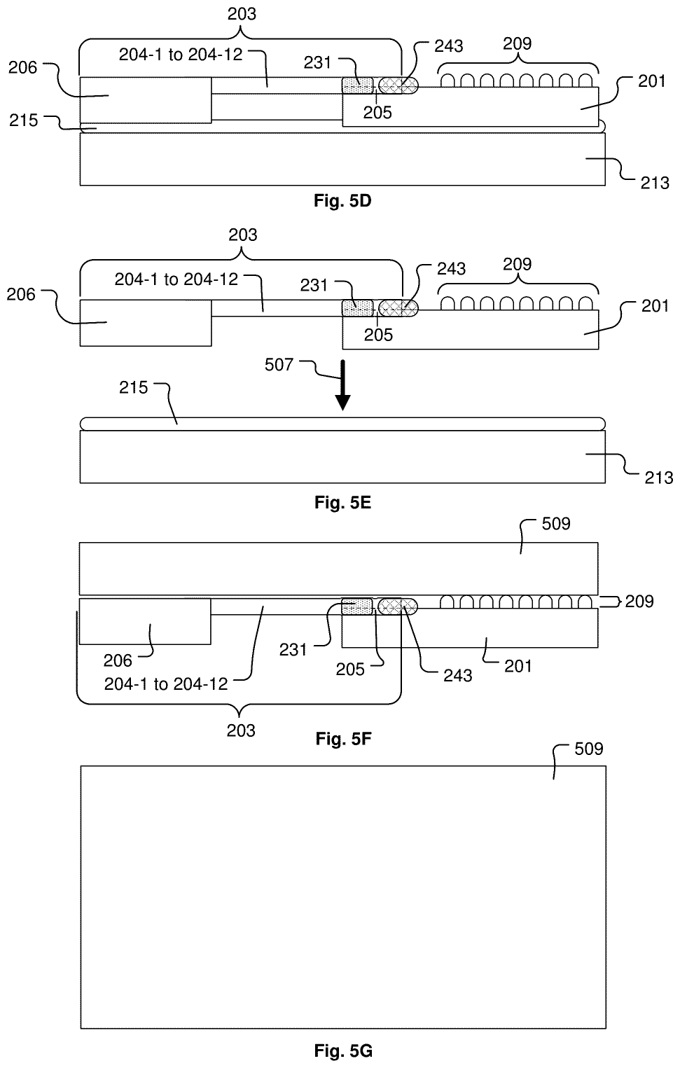

FIG. 4 shows a flowchart of a method for attaching the FAU 203 to the PIC 201, without leaving the buffer structure 230 secured to the FAU 203 and PIC 201, in accordance with some embodiments. The method of FIG. 4 includes an operation 401 for having the PIC 201 and the FAU 203 as separate components that are to be attached to each other. The method continues with an operation 403 for securing the PIC 201 to the carrier 213 by use of a securing material 215. FIG. 5A shows a vertical cross-section of the PIC 201 attached to the carrier 213 by way of the securing material 215, in accordance with some embodiments. In some embodiments, the securing material 215 is a removable securing material, such as a thermal release film or other type of temporary adhesive, in accordance with some embodiments. In some embodiments, the carrier 213 is a silicon substrate, such as a silicon wafer. In some embodiments, the carrier 213 is a glass substrate. It should be understood that the carrier 213 can be formed of any material that is usable as a carrier wafer or carrier substrate in the art of semiconductor manufacturing. In some embodiments, the carrier 213 is intended to be permanently attached to the PIC 201. In these embodiments, the securing material 215 is a permanent securing material, such as an epoxy or other type of permanent adhesive.

The method continues with an operation 405 for securing the FAU 203 to the carrier 213 by way of the securing material 215, such that the optical fibers 204-1 to 204-12 of the FAU 203 are respectively disposed within the v-grooves 211-1 to 211-12 of the v-groove array 210 within the fiber attachment region 205 of the PIC 201, such as shown in FIG. 5A. The method continues with an operation 407 for disposing the structural adhesive 231 over the optical fibers 204-1 to 204-12 within the fiber attachment region 205 of the PIC 201, such as shown in FIG. 5A. The structural adhesive 231 is disposed such that the portion 232 of the optical fibers 204-1 to 204-12 within the fiber attachment region 205 of the PIC 201 does not have the structural adhesive 231 disposed thereon. More specifically, the structural adhesive 231 is disposed over the optical fibers 204-1 to 204-12 at a location away from the ends of the optical fibers 204-1 to 204-12, so as to avoid optical interference of the structural adhesive 231 with light transfer into and/or out of the optical fibers 204-1 to 204-12. The method of FIG. 4 also includes an operation 409 for disposing the optical index matching adhesive 243 over the portion 232 of the optical fibers 204-1 to 204-12 within the fiber attachment region 205 of the PIC 201 that does not have the structural adhesive 231 disposed thereon. In some embodiments, the optical index matching adhesive 243 is disposed over the ends of the optical fibers 204-1 to 204-12 through which light enters and/or exits the optical fibers 204-1 to 204-12. In some embodiments, the operations 407 and 409 are performed sequentially. In some embodiments, the operation 407 is performed before the operation 409. In some embodiments, the operation 407 is performed after the operation 409. In some embodiments, the operations 407 and 409 are performed at the same time.

FIG. 5A shows a vertical cross-section of the PIC 201 and the FAU 203 attached to the carrier 213 by way of the securing material 215, with the optical fibers 204-1 to 204-12 of the FAU 203 disposed within the v-grooves 211-1 to 211-12 of the PIC 201, and with both the structural adhesive 231 and the optical index matching adhesive 243 disposed over the optical fibers 204-1 to 204-12 within the fiber attachment region 205 of the PIC 201, in accordance with some embodiments. FIG. 5B shows a close-up of a top view of any one of the optical fibers 204-1 to 204-12 disposed within its respective v-groove 211-1 to 211-12, with both the structural adhesive 231 and the optical index matching adhesive 243 disposed over the optical fibers 204-1 to 204-12, in accordance with some embodiments.

The method of FIG. 4 continues from the operation 409 with an operation 411 for disposing an adhesion-free buffer structure 501 onto both the structural adhesive 231 and the optical index matching adhesive 243, over the optical fibers 204-1 to 204-12 within the fiber attachment region 205 of the PIC 201. FIG. 5C shows the configuration of FIG. 5A with the adhesion-free buffer structure 501 disposed onto both the structural adhesive 231 and the optical index matching adhesive 243, over the optical fibers 204-1 to 204-12 within the fiber attachment region 205 of the PIC 201, as indicated by arrow 505, in accordance with some embodiments. In some embodiments, the adhesion-free buffer structure 501 includes a non-adhesive interaction layer 503 disposed across a bottom surface of the adhesion-free buffer structure 501. The non-adhesive interaction layer 503 blocks both the structural adhesive 231 and the optical index matching adhesive 243 from contacting the adhesion-free buffer structure 501. The non-adhesive interaction layer 503 does not adhere to the structural adhesive 231 or the optical index matching adhesive 243 after they are cured, such as cured by UV light. In some embodiments, the adhesion-free buffer structure 501 is configured to substantially cover both the structural adhesive 231 and the optical index matching adhesive 243, over the optical fibers 204-1 to 204-12 within the fiber attachment region 205 of the PIC 201. In various embodiments, the adhesion-free buffer structure 501 is formed of aluminum, stainless steel, silicon, quartz, plastic, ceramic, or essentially any other material used in semiconductor fabrication that has sufficient mechanical strength to press and hold the optical fibers 204-1 to 204-12 within their respective v-grooves 211-1 to 211-12. In various embodiments, the adhesion-free buffer structure 501 has essentially any vertical thickness as needed to provide sufficient mechanical strength to press and hold the optical fibers 204-1 to 204-12 within their respective v-grooves 211-1 to 211-12.

The method of FIG. 4 continues from the operation 411 with an operation 413 for curing both the structural adhesive 231 and the optical index matching adhesive 243 while the adhesion-free buffer structure 501 is applying the downward force to the optical fibers 204-1 to 204-12. In some embodiments, UV light is used to affect curing of both the structural adhesive 231 and the optical index matching adhesive 243.

The method of FIG. 4 continues from the operation 413 with an operation 415 for removing the adhesion-free buffer structure 501 from the optical fibers 204-1 to 204-12. It should be understood that the non-adhesive interaction layer 503 prevents the adhesion-free buffer structure 501 from adhering to each of the structural adhesive 231 and the optical index matching adhesive 243, so as to enable removal of the adhesion-free buffer structure 501 from the optical fibers 204-1 to 204-12 in operation 415. FIG. 5D shows the configuration of FIG. 5C, with the adhesion-free buffer structure 501 removed from the optical fibers 204-1 to 204-12 after curing of the structural adhesive 231 and the optical index matching adhesive 243, in accordance with some embodiments.

The method of FIG. 4 continues from the operation 415 with an operation 417 for releasing the PIC 201 and the FAU 203 from the carrier 213. FIG. 5E shows the PIC 201 and the FAU 203 being released from the carrier 213, as indicated by arrow 507, in accordance with some embodiments. FIG. 5F shows a chip 509 flip-chip attached to the PIC 201 after release of the FAU 203 and the PIC 201 from the carrier 213, in accordance with some embodiments. The chip 509 is an integrated circuit chip. FIG. 5G shows a top view of the chip 509, in accordance with some embodiments. It should be appreciated that the chip 509 is configured to extend over the fiber attachment region 205 of the PIC 201 without requiring a cutout region to accommodate any structure, e.g., buffer structure 230, disposed over the fiber attachment region 205 of the PIC 201. Also, in some embodiments, the vertical distance 223 of the FAU 203 above the top surface of the PIC 201 is less than the vertical distance 225 of the electrically conductive bumps 209 above the top surface of the PIC 201, such that the chip 509 can extend in a continuous manner over the fiber attachment region 205 of the PIC 201 when the chip 509 is flip-chip connected to the PIC 201 by way of the electrically conductive bumps 209. It should be appreciated that by not having to form a cutout region within the chip 509, the manufacturing of the chip 509 is simplified and the cost of the chip 509 is correspondingly decreased. Also, by not having a cutout region within the chip 509, the overall area of the chip 509 that is available for use in forming electronic devices and/or wiring is increased, which affords implementation of additional functionality within the chip 509 and eases floorplan crowding within the chip 509, among other benefits.

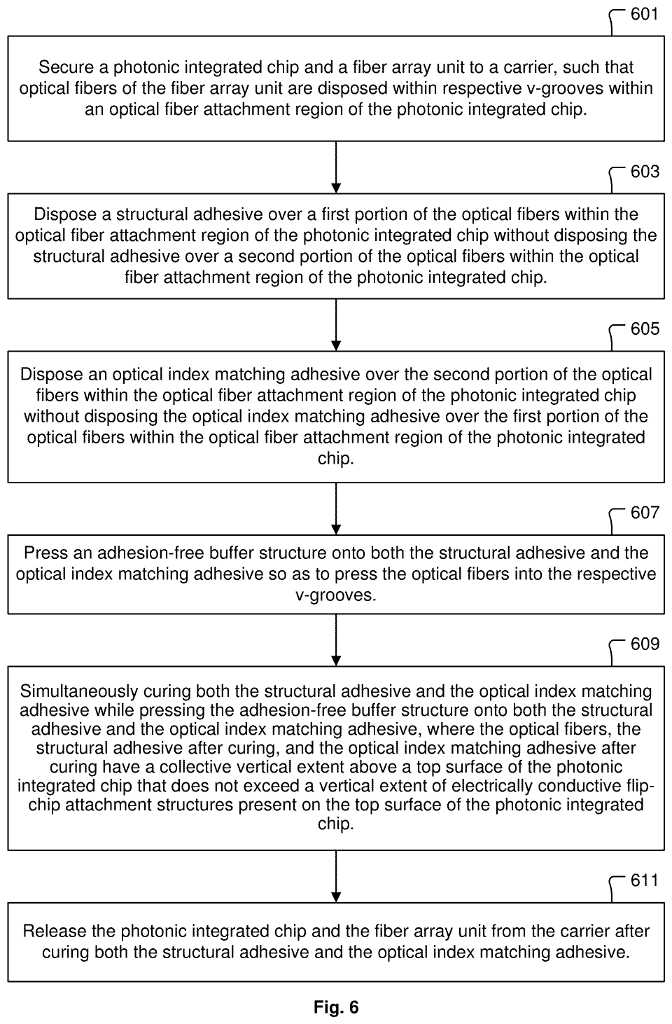

FIG. 6 shows a flowchart of a method for attaching the optical fibers 204-1 to 204-12 to the PIC 201, in accordance with some embodiments. The method includes an operation 601 for securing the PIC 201 and the FAU 203 to the carrier 213, such that optical fibers 204-1 to 204-12 of the FAU 203 are disposed within respective v-grooves 211-1 to 211-12 within an optical fiber attachment region 205 of the PIC 201. The method also includes an operation 603 for disposing a structural adhesive, e.g., 231, over a first portion of the optical fibers 204-1 to 204-12 within the optical fiber attachment region 205 of the PIC 201 without disposing the structural adhesive over a second portion of the optical fibers 204-1 to 204-12 within the optical fiber attachment region 205 of the PIC 201. In some embodiments, the first adhesive is a structural adhesive. The method also includes an operation 605 for disposing an optical index matching adhesive, e.g., 243, over the second portion of the optical fibers 204-1 to 204-12 within the optical fiber attachment region 205 of the PIC 201 without disposing the optical index matching adhesive over the first portion of the optical fibers 204-1 to 204-12 within the optical fiber attachment region 205 of the PIC 201. The method also includes an operation 607 for pressing the adhesion-free buffer structure 501 onto both the structural adhesive and the optical index matching adhesive so as to press the optical fibers 204-1 to 204-12 into the respective v-grooves 211-1 to 211-12. In some embodiments, the adhesion-free buffer structure 501 includes the non-adhesive interaction layer 503 disposed on surface of the adhesion-free buffer structure 501 that presses on the structural adhesive and the optical index matching adhesive. The method also includes an operation 609 for simultaneously curing both the structural adhesive and the optical index matching adhesive while pressing the adhesion-free buffer structure 501 onto both the structural adhesive and the optical index matching adhesive and the optical fibers. In some embodiments, UV light is used for curing each of the structural adhesive and the optical index matching adhesive. The optical fibers 204-1 to 204-12, the structural adhesive after curing, and the optical index matching adhesive after curing have a collective vertical extent above the top surface of the PIC 201 that does not exceed the vertical extent of electrically conductive flip-chip attachment structures present on the top surface of the PIC 201, e.g., the electrically conductive bumps 209. In some embodiments, the method also includes an operation 611 for releasing the PIC 201 and the FAU 203 from the carrier 213 after simultaneously curing both the structural adhesive and the optical index matching adhesive.

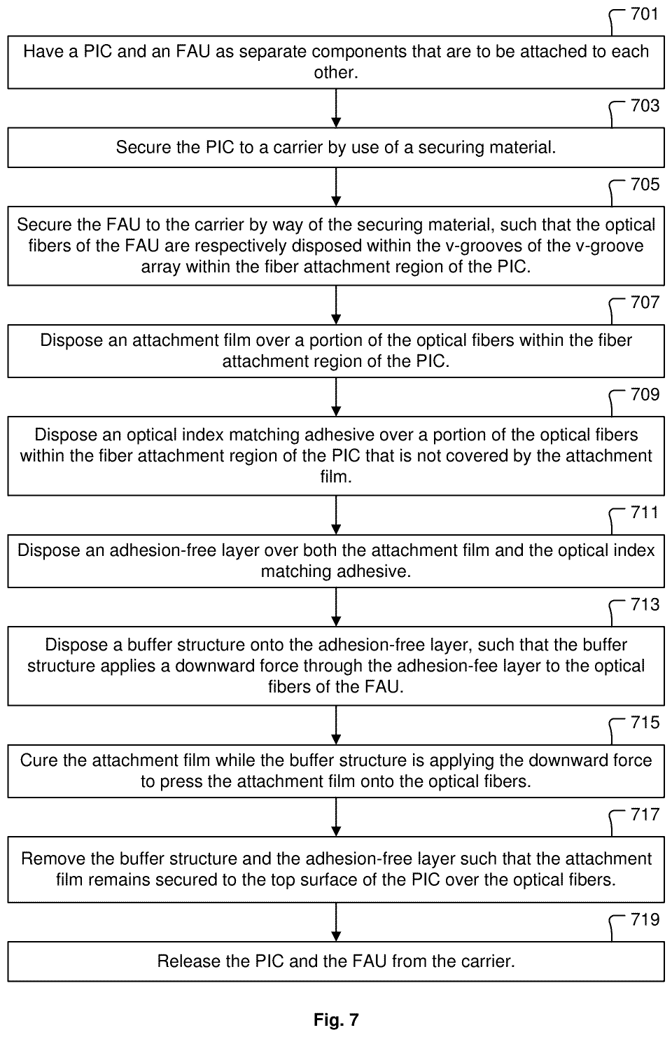

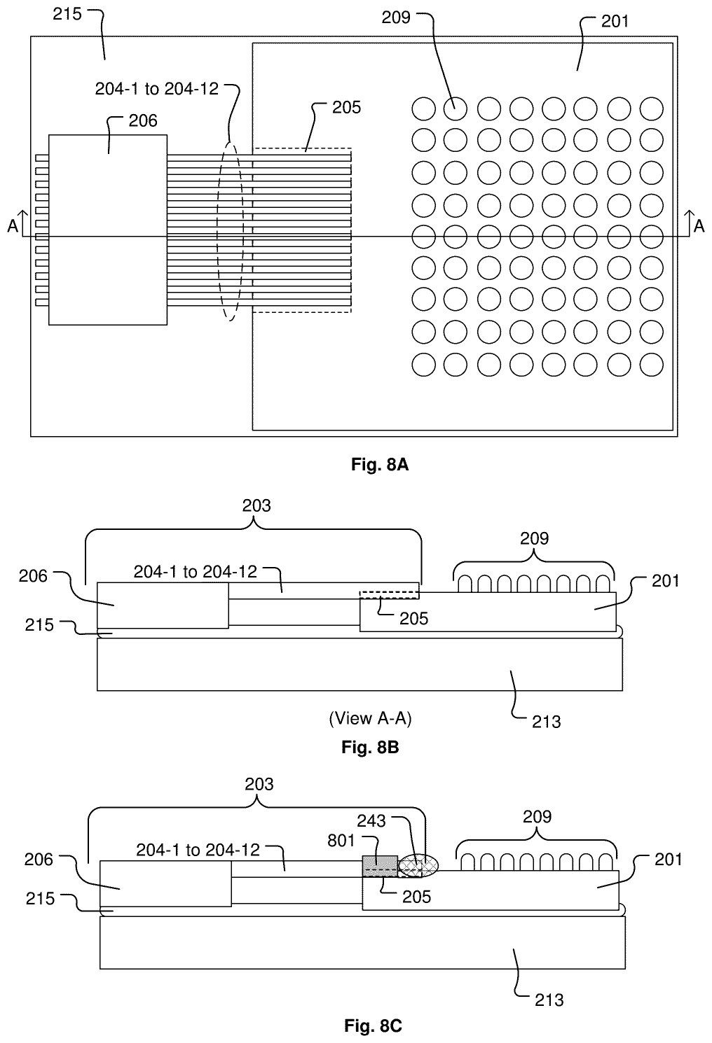

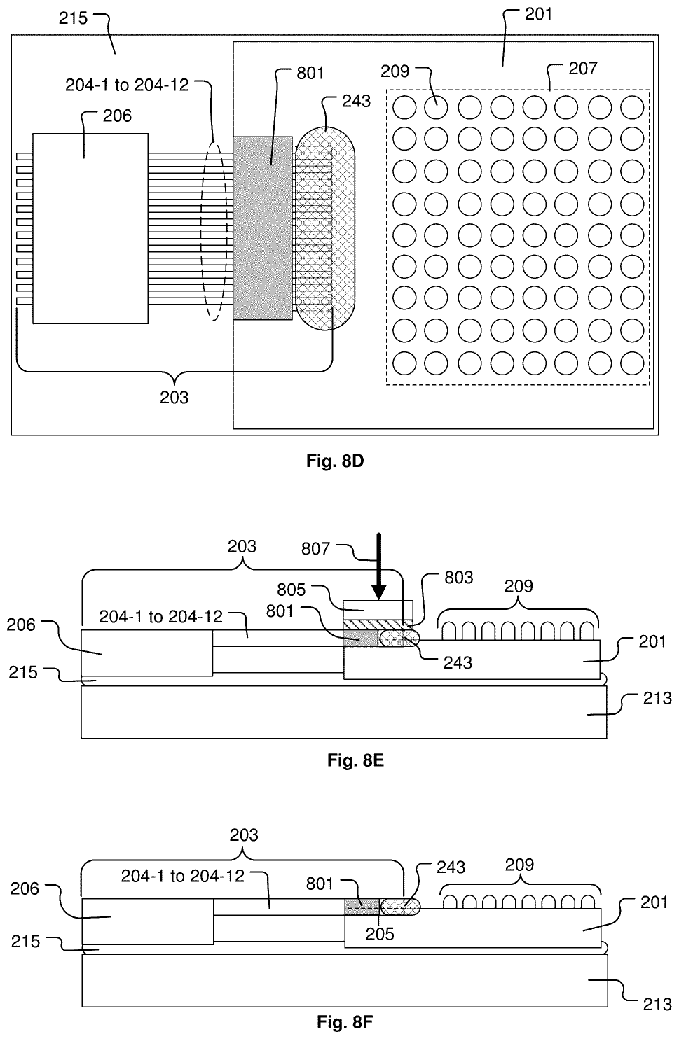

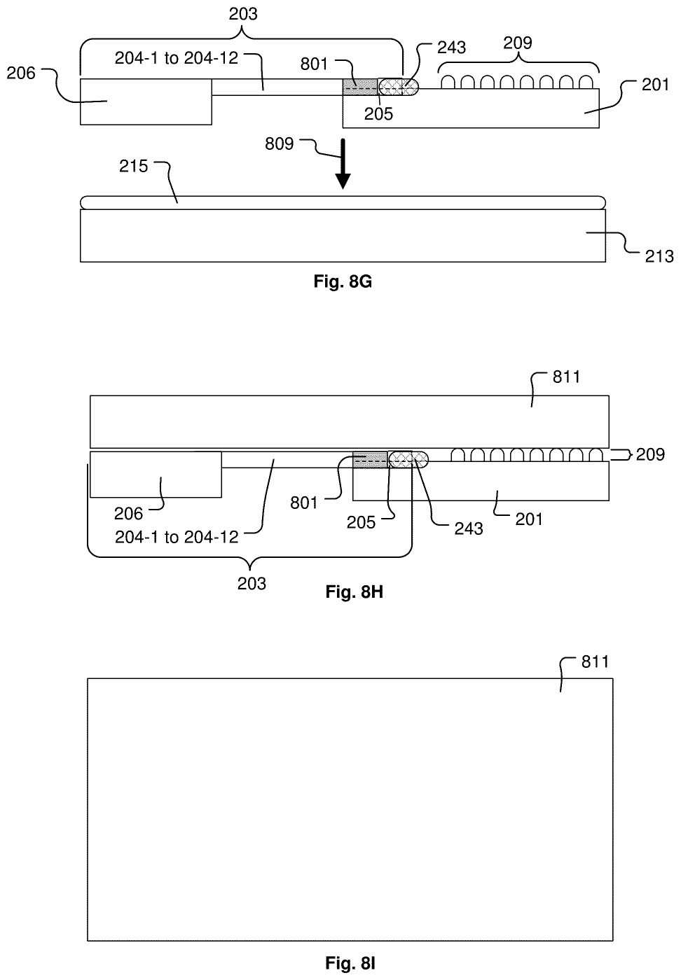

FIG. 7 shows a flowchart of a method for attaching the FAU 203 to the PIC 201, without leaving the buffer structure 230 secured to the FAU 203 and PIC 201, in accordance with some embodiments. The method of FIG. 7 includes an operation 701 for having the PIC 201 and the FAU 203 as separate components that are to be attached to each other. The method continues with an operation 703 for securing the PIC 201 to the carrier 213 by use of the securing material 215. FIG. 8A shows a top view of the PIC 201 attached to the carrier 213 by way of the securing material 215, in accordance with some embodiments. FIG. 8B shows a vertical cross-section view of the PIC 201 attached to the carrier 213 by way of the securing material 215, referenced as View A-A in FIG. 8A, in accordance with some embodiments. In some embodiments, the securing material 215 is a removable securing material, such as a thermal release film or other type of temporary adhesive, in accordance with some embodiments. In some embodiments, the carrier 213 is a silicon substrate, such as a silicon wafer. In some embodiments, the carrier 213 is a glass substrate. It should be understood that the carrier 213 can be formed of any material that is usable as a carrier wafer or carrier substrate in the art of semiconductor manufacturing. In some embodiments, the carrier 213 is intended to be permanently attached to the PIC 201. In these embodiments, the securing material 215 is a permanent securing material, such as an epoxy or other type of permanent adhesive. The method continues with an operation 705 for securing the FAU 203 to the carrier 213 by way of the securing material 215, such that the optical fibers 204-1 to 204-12 of the FAU 203 are respectively disposed within the v-grooves 211-1 to 211-12 of the v-groove array 210 within the fiber attachment region 205 of the PIC 201, such as shown in FIG. 8B.

The method of FIG. 7 continues from the operation 705 with an operation 707 for disposing an attachment film 801 onto the optical fibers 204-1 to 204-12 within the fiber attachment region 205 of the PIC 201. In some embodiments, the attachment film 801 is a thermally curable film or thin plate. In some embodiments, the attachment film 801 is a UV light curable film or thin plate. In some embodiments, the attachment film 801 is die attachment film. The method also includes an operation 709 for disposing the optical index matching adhesive 243 over a portion of the optical fibers 204-1 to 204-12 within the fiber attachment region 205 of the PIC 201. FIG. 8C shows a vertical cross-section view through the configuration of FIG. 8B with the attachment film 801 disposed onto the optical fibers 204-1 to 204-12, in accordance with some embodiments. The optical index matching adhesive 243 is disposed over a portion of the optical fibers 204-1 to 204-12 within the fiber attachment region 205 of the PIC 201 that does not have attachment film 801 disposed thereon. In some embodiments, the optical index matching adhesive 243 is disposed over the ends of the optical fibers 204-1 to 204-12 through which light enters and/or exits the optical fibers 204-1 to 204-12. In some embodiments, the operations 707 and 709 are performed sequentially. In some embodiments, the operation 707 is performed before the operation 709. In some embodiments, the operation 707 is performed after the operation 709. In some embodiments, the operations 707 and 709 are performed at the same time. FIG. 8D shows a top view of the FAU 203 and the PIC 201 secured to the carrier 213 by way of the securing material 215, with the attachment film 801 and the optical index matching adhesive 243 disposed over the optical fibers 204-1 to 204-12, in accordance with some embodiments.

The method of FIG. 7 continues from the operation 709 with an operation 711 for disposing an adhesion-free layer 803 over both the attachment film 801 and the optical index matching adhesive 243 within the fiber attachment region 205 of the PIC 201. The method continues from the operation 711 with an operation 713 for disposing a buffer structure (or clamp structure) 805 onto the adhesion-free layer 803 overlying both the attachment film 801 and the optical index matching adhesive 243 within the fiber attachment region 205 of the PIC 201. FIG. 8E shows the configuration of FIG. 8C with the buffer structure 805 disposed on the adhesion-fee layer 803, in accordance with some embodiments. The operation 713 also includes using the buffer structure 805 to apply a downward force through the adhesion-free layer 803 to the optical fibers 204-1 to 204-12 within the fiber attachment region 205 of the PIC 201. FIG. 8E shows the buffer structure applying the downward force through the adhesion-free layer 803 to the optical fibers 204-1 to 204-12 within the fiber attachment region 205 of the PIC 201, as indicated by arrow 807.

The adhesion-free layer 803 does not adhere to either attachment film 801 or the optical index matching adhesive 243 after they are cured. The adhesion-free layer 803 is also impermeable to both the attachment film 801 and the optical index matching adhesive 243, so as to prevent the buffer structure 805 from contacting the attachment film 801 and/or the optical index matching adhesive 243. In various embodiments, the buffer structure 805 is formed of aluminum, stainless steel, silicon, quartz, plastic, ceramic, or essentially any other material used in semiconductor fabrication that has sufficient mechanical strength to press and hold the optical fibers 204-1 to 204-12 within their respective v-grooves 211-1 to 211-12. In various embodiments, the buffer structure 805 has essentially any vertical thickness as needed to provide sufficient mechanical strength to press and hold the optical fibers 204-1 to 204-12 within their respective v-grooves 211-1 to 211-12.

The method of FIG. 7 continues from the operation 713 with an operation 715 for curing of the attachment film 801 and the optical index matching adhesive 243 while the buffer structure 805 is pressing the attachment film 801 onto the optical fibers 204-1 to 204-12. In some embodiments, the attachment film 801 is cured thermally and/or by UV light. In some embodiments, the optical index matching adhesive 243 is cured thermally and/or by UV light.

The method of FIG. 7 continues from the operation 715 with an operation 717 for removing the buffer structure 805 and the adhesion-free layer 803 after curing of the attachment film 801 and the optical index matching adhesive 243. It should be understood that the attachment film 801 is secured to the top surface of the PIC 201 after the attachment film 801 is cured in the operation 715, which enables release of the adhesion-free layer 803 from the attachment film 801. FIG. 8F shows the configuration of FIG. 8E after removal of the buffer structure 805 and the adhesion-free layer 803 in the operation 717, in accordance with some embodiments. FIG. 8F shows a vertical cross-section view through the PIC 201, with the FAU 203 disposed within a fiber attachment region 205 of the PIC 201, and with the cured attachment film 801 and the cured optical index matching adhesive 243 securing the optical fibers 204-1 to 204-12 within the v-grooves 211-1 to 211-12 of the PIC 201, in accordance with some embodiments. The method of FIG. 7 continues from the operation 717 with an operation 719 for releasing the PIC 201 and the FAU 203 from the carrier 213. FIG. 8G shows the configuration of FIG. 8F with the PIC 201 and the FAU 203 being released from the carrier 213, as indicated by arrow 809, in accordance with some embodiments.

FIG. 8H shows the PIC 201 and the FAU 203 configuration of FIG. 8G with a chip 811 flip-chip attached to the PIC 201, in accordance with some embodiments. The chip 811 is an integrated circuit chip. FIG. 8I shows a top view of the chip 811, in accordance with some embodiments. It should be appreciated that the chip 811 is configured to extend over the fiber attachment region 205 of the PIC 201 without requiring a cutout region to accommodate any structure, e.g., buffer structure 230, disposed over the fiber attachment region 205 of the PIC 201. Also, in some embodiments, the vertical distance 223 of the combination of the FAU 203 and the attachment film 801 above the top surface of the PIC 201 is less than the vertical distance 225 of the electrically conductive bumps 209 above the top surface of the PIC 201, such that the chip 811 can extend in a continuous manner over the fiber attachment region 205 of the PIC 201 when the chip 811 is flip-chip connected to the PIC 201 by way of the electrically conductive bumps 209. It should be appreciated that by not having to form a cutout region within the chip 811, the manufacturing of the chip 811 is simplified and the cost of the chip 811 is corresponding decreased. Also, by not having a cutout region within the chip 811, the overall area of the chip 811 that is available for use in forming electronic devices and/or wiring is increased, which affords implementation of additional functionality within the chip 811 and eases floorplan crowding within the chip 811, among other benefits.

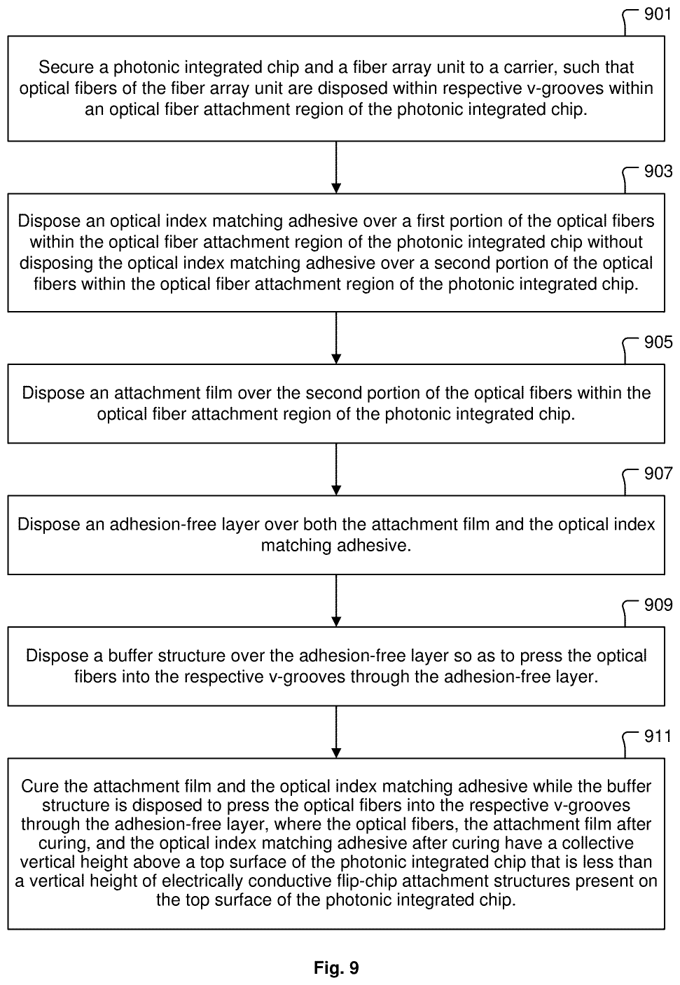

FIG. 9 shows a flowchart of a method for attaching optical fibers to a photonic integrated chip. The method includes an operation 901 for securing a photonic integrated chip and a fiber array unit to a carrier, such that optical fibers of the fiber array unit are disposed within respective v-grooves within an optical fiber attachment region of the photonic integrated chip. The method also includes an operation 903 for disposing an optical index matching adhesive over a first portion of the optical fibers within the optical fiber attachment region of the photonic integrated chip without disposing the optical index matching adhesive over a second portion of the optical fibers within the optical fiber attachment region of the photonic integrated chip. The method also includes an operation 905 for disposing an attachment film over the second portion of the optical fibers within the optical fiber attachment region of the photonic integrated chip. The method also includes an operation 907 for disposing an adhesion-free layer over both the attachment film and the optical index matching adhesive. The method also includes an operation 909 for disposing a buffer structure over the adhesion-free layer so as to press the optical fibers into the respective v-grooves through the adhesion-free layer. In some embodiments, the adhesion-free layer is integrated with the buffer structure such that the buffer structure is used to dispose the adhesion-free layer over both the attachment film and the optical index matching adhesive. The method also includes an operation 911 for curing the attachment film and the optical index matching adhesive while the buffer structure is disposed to press the optical fibers into the respective v-grooves through the adhesion-free layer. In some embodiments, one or more of the attachment film and the optical index matching adhesive is thermally cured. In some embodiments, one or more of the attachment film and the optical index matching adhesive is cured by ultraviolet light. The optical fibers, the attachment film after curing, and the optical index matching adhesive after curing have a collective vertical height above a top surface of the photonic integrated chip that is less than a vertical height of electrically conductive flip-chip attachment structures present on the top surface of the photonic integrated chip. In some embodiments, the method further includes releasing the photonic integrated chip and the fiber array unit from the carrier after curing of the attachment film and the optical index matching adhesive.

It should be understood that each of the methods disclosed herein can be performed in the same manner as disclosed herein but with the PIC 201 having wire bond electrical connections to another electronic device, instead of (or in addition to) having the flip-chip electrical connections to another electronic device by way of the electrically conductive bumps 209. Also, it should be understood that any of the configurations resulting from any of the methods disclosed herein, with the FAU 203 (or bare optical fibers 204-1 to 204-12) attached to the PIC 201, can be disposed on essentially any type of package substrate and/or interposer device and/or fan-out device and/or printed circuit board, or combination thereof. Also, in some embodiments, upon completion of any of the methods disclosed herein to attach the FAU 203 (or bare optical fibers 204-1 to 204-12) to the PIC 201, the PIC 201 is also electrically connected and attached to an interposer (or fan-out) device to which another semiconductor chip is also attached, with electrical connections made between the PIC 201 and the other semiconductor chip through the interposer (or fan-out) device.

The FAU 203 (optical fibers 204-1 to 204-12)-to-PIC 201 attachment processes disclosed herein provide for removal of the buffer structure 230 on top of the one-sided lidded FAU 203 (optical fibers 204-1 to 204-12). Removal of the buffer structure 230 from the location over the optical fibers 204-1 to 204-12 within the v-grooves 211-1 to 211-12 of the PIC 201 provides several advantages. For example, removal of the buffer structure 230 from the location over the optical fibers 204-1 to 204-12 within the v-grooves 211-1 to 211-12 allows for attachment of a chip/substrate to the PIC 201, where the chip/substrate does not have a cut-out region, e.g., 253, to accommodate the presence of the buffer structure 230, which simplifies and facilitates the process of attaching the chip/substrate to the PIC 201. Also, because the chip/substrate that is to attach to the PIC 201 does not have to incorporate the cut-out region, e.g., 253, to avoid the buffer structure 230, the chip/substrate has more area available for electronic devices and/or wire routing. Additionally, removal of the buffer structure 230 from over the optical fibers 204-1 to 204-12 within the v-grooves 211-1 to 211-12 provides for hiding of the v-grooves 211-1 to 211-12 and waveguide area on the PIC 201, which gives the overall PIC 201 and associated packaging a cleaner appearance that may be more visually appealing to the customer. Additionally, removal of the buffer structure 230 from over the optical fibers 204-1 to 204-12 within the v-grooves 211-1 to 211-12 provides for at least one less component in the manufacturing process, which reduces the qualification uncertainty and improves the overall reliability of the PIC 201 and associated package assembly. Also, because the chip/substrate that is flip-chip attached to the PIC 201 extends over the optical fiber attachment region 205 of the PIC 201, the chip/substrate serves to protect the optical fibers 204-1 to 204-12 secured within the v-grooves 211-1 to 211-12, which improves operational reliability of the PIC 201.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other housekeeping operations may be performed in between method operations, and/or method operations may be adjusted so that they occur at slightly different times or simultaneously or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

1. A method for attaching optical fibers to a photonic integrated chip, comprising:
securing a photonic integrated chip and a fiber array unit to a carrier, such that optical fibers of the fiber array unit are disposed within respective v-grooves within an optical fiber attachment region of the photonic integrated chip;
disposing a structural adhesive over a first portion of the optical fibers within the optical fiber attachment region of the photonic integrated chip without disposing the structural adhesive over a second portion of the optical fibers within the optical fiber attachment region of the photonic integrated chip;
disposing an optical index matching adhesive over the second portion of the optical fibers within the optical fiber attachment region of the photonic integrated chip;
disposing an adhesion-free buffer structure onto both the structural adhesive and the optical index matching adhesive so as to press the optical fibers into the respective v-grooves; and
curing both the structural adhesive and the optical index matching adhesive while the adhesion-free buffer structure is disposed onto both the structural adhesive and the optical index matching adhesive,
wherein the optical fibers, the structural adhesive after curing, and the optical index matching adhesive after curing have a collective vertical height above a top surface of the photonic integrated chip that is less than a vertical height of electrically conductive flip-chip attachment structures present on the top surface of the photonic integrated chip.

2. The method of claim 1, wherein the adhesion-free buffer structure includes a non-adhesive interaction layer disposed on surface of the adhesion-free buffer structure that presses on the structural adhesive and the optical index matching adhesive.

3. The method of claim 1, wherein the optical index matching adhesive is disposed to cover ends of the optical fibers.

4. The method of claim 1, wherein curing of both the structural adhesive and the optical index matching adhesive is done using ultraviolet light.

5. The method of claim 1, further comprising:
releasing the photonic integrated chip and the fiber array unit from the carrier after curing of both the structural adhesive and the optical index matching adhesive.

6. An apparatus, comprising:
a photonic integrated chip including a plurality of v-grooves for connection of optical fibers;
a plurality of flip-chip attachment structures disposed on a top surface of the photonic integrated chip, each of the plurality of flip-chip attachment structures having a vertical height above the top surface of the photonic integrated chip;
a fiber array unit including a plurality of optical fibers disposed respectively within the plurality of v-grooves of the photonic integrated chip;
a structural adhesive disposed and cured over a first portion of the optical fibers within the v-grooves of the photonic integrated chip;
an optical index matching adhesive disposed and cured over a second portion of the optical fibers within the v-grooves of the photonic integrated chip, wherein the second portion of the optical fibers does not have the structural adhesive disposed thereon;
wherein the optical fibers, the structural adhesive, and the optical index matching adhesive have a collective vertical height above the top surface of the photonic integrated chip that is less than the vertical height of the plurality of flip-chip attachment structures above the top surface of the photonic integrated chip.

7. The apparatus as recited in claim 6, wherein the plurality of v-grooves are disposed along a peripheral edge of the photonic integrated chip.

8. The apparatus as recited in claim 6, wherein the structural adhesive and the optical index matching adhesive have a substantially same vertical height above the top surface of the photonic integrated chip.

9. The apparatus as recited in claim 6, wherein the photonic integrated chip and the fiber array unit are attached to a carrier wafer.

10. The apparatus as recited in claim 6, further comprising:
an integrated circuit chip flip-chip attached to the photonic integrated chip by way of the plurality of flip-chip attachment structures, the integrated circuit chip extending over the plurality of optical fibers disposed respectively within the plurality of v-grooves of the photonic integrated chip, the integrated circuit chip also extending over both the optical index matching adhesive and the structural adhesive.

11. A method for attaching optical fibers to a photonic integrated chip, comprising:
securing a photonic integrated chip and a fiber array unit to a carrier, such that optical fibers of the fiber array unit are disposed within respective v-grooves within an optical fiber attachment region of the photonic integrated chip;
disposing an optical index matching adhesive over a first portion of the optical fibers within the optical fiber attachment region of the photonic integrated chip without disposing the optical index matching adhesive over a second portion of the optical fibers within the optical fiber attachment region of the photonic integrated chip;
disposing an attachment film over the second portion of the optical fibers within the optical fiber attachment region of the photonic integrated chip;
disposing an adhesion-free layer over both the attachment film and the optical index matching adhesive;
disposing a buffer structure over the adhesion-free layer so as to press the optical fibers into the respective v-grooves through the adhesion-free layer;
curing the attachment film and the optical index matching adhesive while the buffer structure is disposed to press the optical fibers into the respective v-grooves through the adhesion-free layer; and
wherein the optical fibers, the attachment film after curing, and the optical index matching adhesive after curing have a collective vertical height above a top surface of the photonic integrated chip that is less than a vertical height of electrically conductive flip-chip attachment structures present on the top surface of the photonic integrated chip.

12. The method of claim 11, wherein the adhesion-free layer is integrated with the buffer structure such that the buffer structure is used to dispose the adhesion-free layer over both the attachment film and the optical index matching adhesive.

13. The method of claim 11, wherein one or more of the attachment film and the optical index matching adhesive is thermally cured.

14. The method of claim 11, wherein one or more of the attachment film and the optical index matching adhesive is cured by ultraviolet light.

15. The method of claim 11, further comprising:
releasing the photonic integrated chip and the fiber array unit from the carrier after curing of the attachment film and the optical index matching adhesive.

16. An apparatus, comprising:
a photonic integrated chip including a plurality of v-grooves for connection of optical fibers;
a plurality of flip-chip attachment structures disposed on a top surface of the photonic integrated chip, each of the plurality of flip-chip attachment structures having a vertical height above the top surface of the photonic integrated chip;
a fiber array unit including a plurality of optical fibers disposed respectively within the plurality of v-grooves of the photonic integrated chip;
an attachment film disposed and cured over a first portion of the optical fibers within the v-grooves of the photonic integrated chip;
an optical index matching adhesive disposed and cured over a second portion of the optical fibers within the v-grooves of the photonic integrated chip, wherein the second portion of the optical fibers does not have the attachment film disposed thereon;
wherein the optical fibers, the attachment film, and the optical index matching adhesive have a collective vertical height above the top surface of the photonic integrated chip that is less than the vertical height of the plurality of flip-chip attachment structures above the top surface of the photonic integrated chip.

17. The apparatus as recited in claim 16, wherein the plurality of v-grooves are disposed along a peripheral edge of the photonic integrated chip.

18. The apparatus as recited in claim 16, wherein the attachment film and the optical index matching adhesive have a substantially same vertical height above the top surface of the photonic integrated chip.

19. The apparatus as recited in claim 16, wherein the photonic integrated chip and the fiber array unit are attached to a carrier wafer.

20. The apparatus as recited in claim 16, further comprising:
an integrated circuit chip flip-chip attached to the photonic integrated chip by way of the plurality of flip-chip attachment structures, the integrated circuit chip extending over the plurality of optical fibers disposed respectively within the plurality of v-grooves of the photonic integrated chip, the integrated circuit chip also extending over both the optical index matching adhesive and the attachment film.
